(19) United States
(12) Patent Application Publication
(10) Pub. No.: US 2009/0055234 A1
(43) Pub. Date: Feb. 26, 2009

(54) SYSTEM AND METHODS FOR SCHEDULING MEETINGS BY MATCHING A MEETING PROFILE WITH VIRTUAL RESOURCES

(75) Inventors: Yongcheng Li, Cary, NC (US); Li Chen, Cary, NC (US); Lun Xiao, Cary, NC (US); John Raithel Hind, Raleigh, NC (US)

Correspondence Address: AKERMAN SENTERFITT, P. O. BOX 3188, WEST PALM BEACH, FL, 33402-3188, US

(73) Assignee: INTERNATIONAL BUSINESS MACHINES CORPORATION, Armonk, NY (US)

(21) Appl. No.: 11/843,099

(22) Filed: Aug. 22, 2007

(51) Int. Cl. G06Q 10/00

(52) U.S. Cl. 705/8

(57) ABSTRACT

A system for scheduling meetings by matching a scheduler-defined meeting profile against a pool of virtual resources is provided. The system includes an electronic data storage comprising data defining a set of virtual resources, at least one property being associated with each resource. The system also includes a meeting profiler module that is configured to define a meeting profile which specifies one or more resources required for a meeting based upon received user input. The system further includes a profile-resource matching module that searches the data of the electronic data storage and matches elements of the set of virtual resources to the one or more resources required for the meeting defined by the meeting profiler module, and, based thereon, automatically generates at least one meeting schedule candidate.

### FIELD OF THE INVENTION

The present invention is related to the field of information processing, and more particularly, to techniques for scheduling meetings given certain resource constraints.

### BACKGROUND OF THE INVENTION

Despite numerous computer-implemented applications and tools for scheduling meetings, the task of organizing and scheduling meetings can be an arduous task. Many conventional applications and tools typically only perform limited tasks pertaining to scheduling a meeting, such as determining a specific time slot, ascertaining the availability of potential invitees, or sending brief electronic messages regarding a scheduled meeting.

A meeting scheduler often must use a variety of different applications or tools to identify potential participants and reserve an available conference room or schedule a Web-based or telephonic conference, for example. A relatively straightforward task such as organizing a meeting that will require the use of a video projector can require the use of several different applications or tools, and, perhaps more likely, even manual effort on the part of the meeting scheduler. For example, the meeting scheduler likely would need to contact one individual to establish whether a conference room will be available and whether or not the room has video presentation capabilities. If the conference room is available, but does not have a video projector, then it is likely that the meeting scheduler will need to contact yet another individual to determine whether a video projector will be available and can be delivered to the conference room at a specified time.

A critical resource for any meeting, of course, is the individual participants themselves. For any particular individual, there is the likelihood that the individual's calendar includes numerous scheduled meetings or events, and accordingly, it is difficult to ascertain an open time slot to schedule a meeting that the individual can or will wish to attend. Moreover, the individual may assign different priorities to different types of meetings or to meetings occurring at different times. A meeting scheduler may have considerable difficulty in even ascertaining the availability and priorities of potential participants, let alone scheduling a meeting that can accommodate each of a plurality of potential participants.

Moreover, these scheduling difficulties can be exacerbated if for some reason a scheduled meeting must subsequently be rescheduled for any reason. The meeting scheduler must, for example, determine anew the various times that potential participants are available, must again find an available conference room or set up a new telephonic or Web-based conference, and must determine the availability of various other resources, such as a video projector or other device, needed for the meeting to be successful.

Conventionally, resources such as participant and conference room availabilities have typically been treated as members of resource pools to be drawn as needed for a particular meeting or series of meetings. Under this pooling approach, however, meeting resources are typically only defined statically, and thus the approach is usually only applicable to a relatively small subset of resource types (e.g., a conference room with a ten-person capacity). More fundamentally, conventional approaches to meeting scheduling do not permit a meeting scheduler to dynamically define meeting requirements or ascertain particular properties associated with different resources that may be needed for a meeting. Accordingly, conventional approaches generally do not provide a mechanism for searching a pool of resources, wherein each resource has one or more associated properties, so as to determine a best mix of resources for scheduling a meeting given the constraints of resource availability.

### SUMMARY OF THE INVENTION

The invention is directed to systems and methods for automatically scheduling meetings. One embodiment of the invention, is a computer-implemented method for scheduling meetings by matching a scheduler-defined meeting profile against a pool of virtual resources. The method can include electronically storing data that defines a set of virtual resources, each resource having associated therewith at least one property. The method also can include generating a meeting profile that specifies one or more resources required for a meeting based upon received user input. Additionally, the method can include electronically searching the stored data to match elements of the set of virtual resources to the one or more resources required for the meeting, and automatically generating at least one meeting schedule candidate based upon the match. The method further can include presenting the at least one meeting schedule candidate to a user.

Another embodiment of the invention is system for scheduling meetings, the system being configured to match a scheduler-defined meeting profile against a pool of virtual resources. The system can include electronic data storage for storing data defining a set of virtual resources, each resource having associated therewith at least one property. The system also can include a meeting profiler module for defining a meeting profile that specifies one or more resources required for a meeting based upon received user input. The system further can include a profile-resource matching module. The profile-resource matching module, more particularly, can be configured to search the data stored in the electronic data storage and, based on the search, to match elements of the set of virtual resources to the one or more resources required for the meeting defined by the meeting profiler module. The system can be further configured to automatically generate at least one meeting schedule candidate based upon the results of the searching and matching.

Yet another embodiment is a computer-readable storage medium in which can be embedded computer-readable code. The code can comprise instructions for causing a computer to electronically store data defining a set of virtual resources, each resource having associated therewith at least one property. The instructions can also cause the computer to generate a meeting profile that specifies one or more resources required for a meeting based upon received user input and to electronically search the stored data so as to match elements of the set of virtual resources to the one or more resources required for the meeting. Additionally, the instructions can cause the computer to automatically generate at least one meeting schedule candidate based upon the match and to present the at least one meeting schedule candidate to a user.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1 is a schematic view of a system for scheduling meetings by matching a scheduler-defined meeting profile against a pool of virtual resources, according to one embodiment of the invention.

FIG. 2 is an exemplary look-up table for computing a matching score for a virtual resource based upon a meeting profile, according to another embodiment of the invention.

FIG. 3 a schematic view of a graphical user interface through which a user can define a meeting profile for matching with virtual resources, according to yet another embodiment of the invention.

FIG. 4 is a schematic view of a graphical user interface for presenting a dialog through which a user can specify resource properties or attributes, according to still another embodiment of the invention.

FIG. 5 is a schematic view of a system for scheduling meetings by matching a scheduler-defined meeting profile against a pool of virtual resources, according to yet another embodiment of the invention

FIG. 6 is a flowchart of exemplary steps in a method for scheduling meetings by matching a scheduler-defined meeting profile against a pool of virtual resources, according to still another embodiment of the invention.

### DETAILED DESCRIPTION

The invention is directed to systems and methods for automatically scheduling meetings. One aspect of the invention is the automatic scheduling of a meeting by matching a scheduler-specified meeting profile against elements of a predetermined set of virtual resources. Accordingly, the invention can provide an extensible model with which resources needed to meet the objectives of a particular meeting can be specified. A search can then be performed, electronically, so as to automatically match available resources with the specified requirements. More particularly, available resources can be prioritized, for example, by a range of numerical values, such that a prioritized list of results can be presented to the meeting scheduler. Thus, a scheduler can establish an optimal meeting schedule given different resource requirements and corresponding resource constraints.

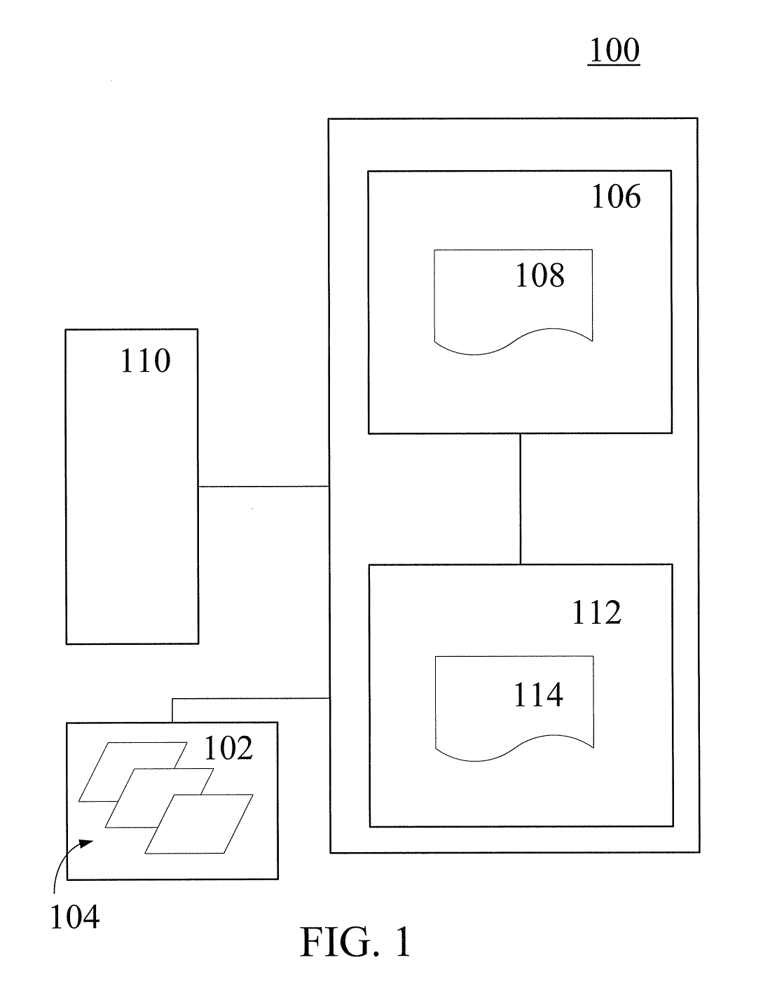

The invention thus can mitigate or eliminate the effort typically exerted in scheduling meetings using conventional systems and techniques. Moreover, according to another aspect of the invention, a meeting schedule can be automatically updated in the event that the availability of one or more needed resources changes before a scheduled meeting takes place. That is, the extensible model allows virtual resources to be defined along with their relevant properties so that when these properties unexpectedly or dynamically change, a meeting can be automatically re-scheduled in light of changing circumstances. Additionally, if the virtual resource model changes owing to new circumstances, thereby giving rise to new resource requirements, the meeting profile can be modified accordingly. Because these procedures can be implemented automatically, worker efficiency and productivity can be significantly enhanced. Additionally, the invention can be readily integrated with an existing calendar system, thereby allowing it to be implemented and utilized in a cost effective manner. Referring initially to FIG. 1, a schematic view is provided illustrating a system 100 that schedules meetings by matching a scheduler-defined meeting profile against a pool of virtual resources, according to one embodiment of the invention. The system 100 illustratively includes electronic data storage 102 for storing data defining a set of virtual resources 104, each resource having one or more associated properties therewith, as described more particularly below. The system 100 also illustratively includes a meeting profiler module 106 for defining a meeting profile 108 that specifies one or more resources required for a meeting based upon received user input. The user input can be supplied through a user interface 110, as also described more particularly below.

The system further illustratively includes a profile-resource matching module 112 that is communicatively linked to the electronic data storage 102 and meeting profiler module 106. Operatively, the profile-resource matching module 112 searches the data of the electronic data storage 102 and matches elements belonging the set of virtual resources 104 against one or more resources required for the meeting as defined by the meeting profile 108 generated by the meeting profiler module 106. Based on the matching, the profile-resource matching module 112 automatically generates at least one meeting schedule candidate 114.

One or both of the profile-resource matching module 112 and the meeting profiler module 106 can be implemented in dedicated hardwired circuitry. Alternatively, the profile-resource matching module 112 and/or the meeting profiler module 106 can be implemented in computer-executable code to run on a computing device, such as a general-purpose computer or application-specific computer, or indeed any other electronic device comprising logic circuitry for executing computer-readable code. In yet another embodiment, one or both of the profile-resource matching module 112 and the meeting profiler module 106 can be implemented in a combination of hardwired circuitry and computer-executable code.

As used herein, the term virtual resource denotes any type of resource that is needed for a particular meeting that is to be scheduled. As noted above, according to the invention, each such resource has one or more associated properties, each of which can vary depending on the requirements of a particular meeting. For example, elements of the set of virtual resources 104 stored in the electronic data storage 102 can include identifiers associated with one or more individuals or potential meeting participants. Associated properties of a participant can include, for example, the participant's availability. A range of numerical values can be assigned to each such property associated with a virtual resource. Thus, a degree of availability corresponding to different time slots that the participant is available can be associated with that participant. For example, a value of 0 might be assigned to a time slot of 7 PM to 6 AM, while 0.2 can be assigned to a time slot of 6 AM to 8 AM. A value of 1 could be assigned to a larger time slot of 8 AM to 5 PM, expressing that the particular participant, as a “virtual resource,” is available any time between 8 AM and 5 PM. Moreover, the numerical values could be assigned by the participant based on an expectation of when the participant expects to be available. Thus, if the participant expects that a conflict may arise in the morning, but not the afternoon, a higher value could be assigned to a 12 noon to 5 PM time slot and a lower value to an 8 AM to 12 noon time slot. Alternatively, the values assigned to different time slots could alternatively, or additionally, reflect the participant's preference for meeting at different times.

Similarly, if one element of the set of virtual resources 104 stored in the electronic data storage 102 is a participant, the location where the participant can attend a meeting can be another associated property. Assessing the location properties of the various participants who are sought to be included in the meeting can dictate whether a conference room should be reserved or, alternatively, whether a conference call or e-conference should be set up. Again, numerical values for the locations accessible to or preferred by each participant can be assigned values from a range of numerical values. The values can be used by the profile-resource matching module 112 in determining a rank ordering or score for different meeting arrangements, as described more particularly below.

Other properties associated with a potential meeting participant can include, for example, a refreshment or food preference if a lunch or dinner is to be served during the meeting. This property, accordingly, can assist the meeting scheduler in arranging a meeting and ordering an optimal combination of food and beverages at a particular meeting time. Still another exemplary property is a business or organization attribute. These attributes, or properties, can specify a participant's capabilities and/or responsibilities within a business or organization. They can be specified by the participant's title, list of project responsibilities, organization responsibilities, technical capabilities, or other attribute.

Another example of a resource that can be included among the elements of the set of virtual resources 104 stored in the electronic data storage 102 is a conference room. Properties that can be associated with a particular conference room include, for example, the seating capacity of the room, whether or not the room includes audio/visual resources that may or may not be needed for a particular meeting. Properties for the conference room can additionally or alternatively include, for example, network capabilities, such as the number of available Ethernet ports, WiFi accessibility, telephony resources, video network access, and a host of other resource attributes associated with the conference room. Likewise, properties for a conference call can include, for example, the maximum number of connections required, as well as calling number, moderator and participant pass codes. An e-meeting, similarly, can have properties such as the maximum number of connections available, the availability of collateral resources (e.g., whiteboard, screen sharing, meeting-room chat, and poll), as well as other properties such as passwords and any file attachments.

In the aggregate, the different virtual resources having associated properties, preferably represented with numerical values, comprise a pool of virtual resources. The pool of virtual resources comprises the elements of the set of virtual resources 104 that are electronically stored in the electronic data storage 102.

The meeting profiler module 106 defines the meeting profile 108 in response to input received from a meeting scheduler. The meeting profile 108 generated by the meeting profiler module 106 in response to received input can specify different virtual resources needed for a particular meeting or for a series of related meetings that are to occur at different intervals over the course of time. Moreover, the meeting profile 108 generated by the meeting profiler module 106 can specify particular properties that each virtual resource necessarily, or preferably, should possess. For example, using the meeting profiler module 106, the meeting scheduler can specify a minimum number of the desired total number of participants that would need to be present at the meeting. The meeting scheduler likewise can specify location and time that the meeting is to take place.

The meeting profiler module 106 can be configured to implement a predetermined grammar that allows the meeting scheduler to specify needed or desired virtual resources and their associated properties using flexible language. For example, the meeting profiler module 106 can recognize statements such as “at least five out of the specified thirteen participants are necessary for the meeting to be valid.” Similarly, the meeting profiler module 106 can recognize statements indicating that one or more designated participants “must be present,” for example. Likewise, for example, the meeting profiler module 106 can recognize a statement such as “the meeting should occur between Tuesday and Friday every three weeks.” The flexible language used, accordingly, can specify a minimum numerical value that must be assigned to any property of a particular virtual resource before the resource can be considered for inclusion in a mix of resources that will define a particular meeting schedule candidate.

Once the meeting profile 108 has been defined and generated by the meeting profiler module 106, the profile-resource matching module 112 performs a search of the pool of virtual resources electronically stored in the data storage 102. More particularly, the profile-resource matching module 112 can be configured to search among the various elements of the set of virtual resources 104 stored in the electronic data storage 102 and compile a list of identified resources satisfying, at least to some degree, the preferences and/or requirements defined by the meeting profile. Each element of the list, as already noted, can have an associated numerical value or score. More particularly, the associated score can be a discrete or continuous numerical value that lies within a predetermined range, which can be arbitrarily set. For example, if the meeting profile 108 specifies that at a designated time a conference room having a seating capacity of thirteen is needed, but the profile-resource matching module 112 determines that a room with capacity for only twelve is available, then a matching score of 0.9 can be associated with the virtual resource by the profile-resource matching module. In this respect, the invention extends conventional “all-or-nothing” matching of resources with meeting requirements, by allowing different values (e.g., a value between zero and one) to be associated with distinct virtual resources having different properties.

According to one embodiment, the profile-resource matching module 112 implements one or more algorithms for calculating matching scores for each virtual resource type. For example, an algorithm for calculating a conference room matching score, based on number of seats available, could be

$$matching score = \{ \begin{matrix}1 , & if expected no . of seats \leq actual no . of seats \\ 1 - ( \frac{\begin{matrix}expected no . of seats - \\ actual no . of seats\end{matrix}}{actual no . of seats} ) , & otherwise .\end{matrix}$$

Similarly, for example, a matching score for the conference room, additionally or alternatively, could be based on whether or not a particular communication or presentation device, such as an audio-visual projector, is available for use with the conference room:

$$matching score = \{ \begin{matrix}0 , & if projector is needed , but unavailable \\ 1 , & otherwise .\end{matrix}$$

As an alternative to such system-based default rules, the system 100 can be configured to permit the customization of rules for calculating matching scores. Accordingly, a meeting scheduler can provide input through the user interface 110 so as specify one or more rules that is implemented by the profile-resource matching module 112 in calculating one or more matching scores pertaining to any of the virtual resources among the set of virtual resources 104 electronically stored in the electronic data storage 102.

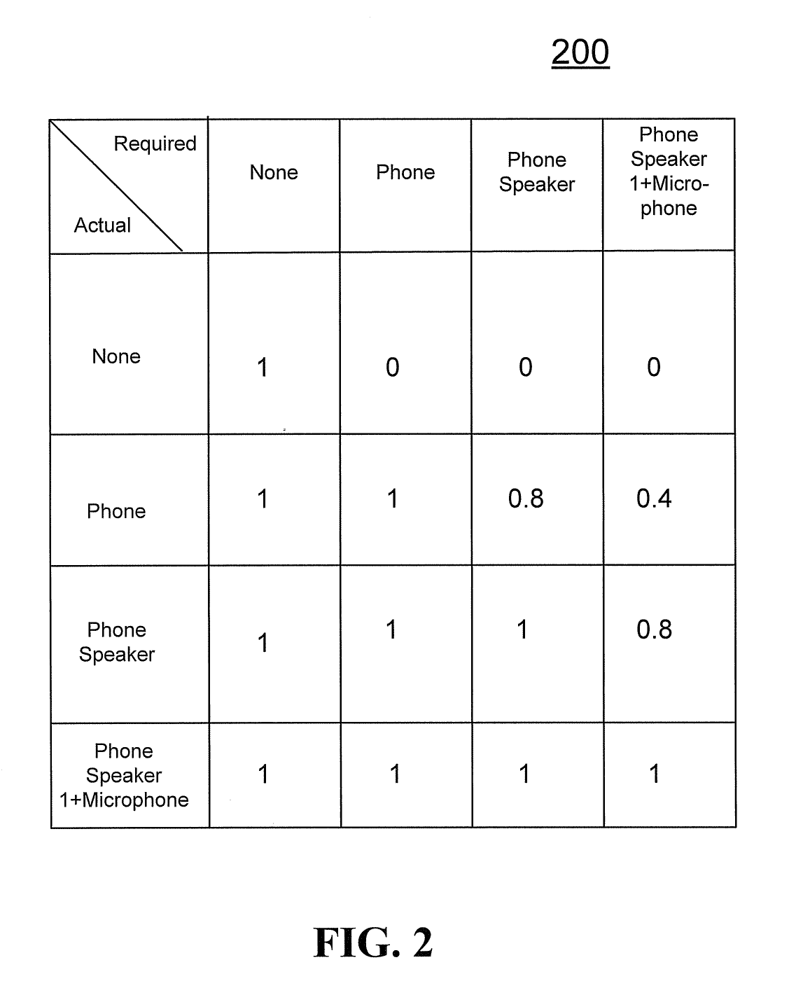

According to still another embodiment, a matching score for a particular resource can be determined by the profile-resource matching module 112 performing a table “look-up, ” as will be readily understood by one of ordinary skill in the art. FIG. 2 illustrates an exemplary look-up table 200 for determining a matching score for a conference room based on the telephonic capabilities associated with the conference room. As shown, the left-hand column specifies different telephonic requirements that can be specified by a meeting scheduler. The top row specifies different capabilities, and the corresponding entries of the table indicate matching scores based on a comparison of requirements versus actual telephonic capabilities.

The profile-resource matching module 112 performs a search and assigns a corresponding matching score for each resource item specified in the meeting profile 108. The searches can be performed iteratively, item-by-item, until no unprocessed items remain among those specified by the meeting profile 108.

Not all virtual resources having the required or preferred properties are necessarily available for scheduling a particular meeting. Perhaps not all required participants are available at a preferred time, for example. Alternatively, all the required participants may be available at the preferred time, but perhaps the only conference room available has less than the number of seats to accommodate each participant. According to one aspect of the invention, therefore, the profile-resource matching module 112 can generate a plurality of alternate meeting schedule candidates, each comprising a different mix of virtual resources. An arrangement comprising a particular mix of virtual resources for a meeting may have to meet some minimum criteria for the profile-resource matching module 112 if it is to be included among the list of meeting schedule candidates. Based upon the matching scores of the different virtual resources associated with any one meeting schedule candidate, an overall score can be computed by the profile-resource matching module 112 for any one meeting schedule candidate.

Each of the meeting schedule candidates can be combined by the profile-resource matching module 112 into a single list of meeting schedule candidates, each meeting schedule candidate having an overall score. The different meeting schedule candidates, accordingly, can be rank ordered based upon their overall scores. The rank ordered meeting schedule candidates can be presented to the meeting schedule by the profile-resource matching module 112 through the user interface 110.

According to one embodiment, the rank ordered meeting schedule candidates are visually presented on a display screen (not shown) of the user interface 110. According to another embodiment, the system 100 is configured to allow a meeting scheduler to select any one of the displayed meeting schedule candidate—for example, by performing a standard point-and-click operation—so as to view the actual match between the meeting profile 108 and the particular virtual resources associated with the selected meeting schedule candidate. Alternatively, or additionally, the system 100 can be configured to allow the meeting scheduler to specify that the meeting schedule candidate having the highest score, or rank ordering, is automatically selected and presented. The system 100 also can be configured to automatically update the list of meeting schedule candidates and/or modify at least one meeting schedule candidate if one or more properties of at least one element of the set of virtual resources 104 changes prior to a scheduled meeting.

The system 100 can be integrated with a meeting scheduler's electronic calendar. Accordingly, the meeting profile 108 optionally can be stored by a system that implements the meeting scheduler's electronic calendar. Such systems can include tools that are extensions of a software-based time management system such as a desk-top accessory and/or mainframe office automation system.

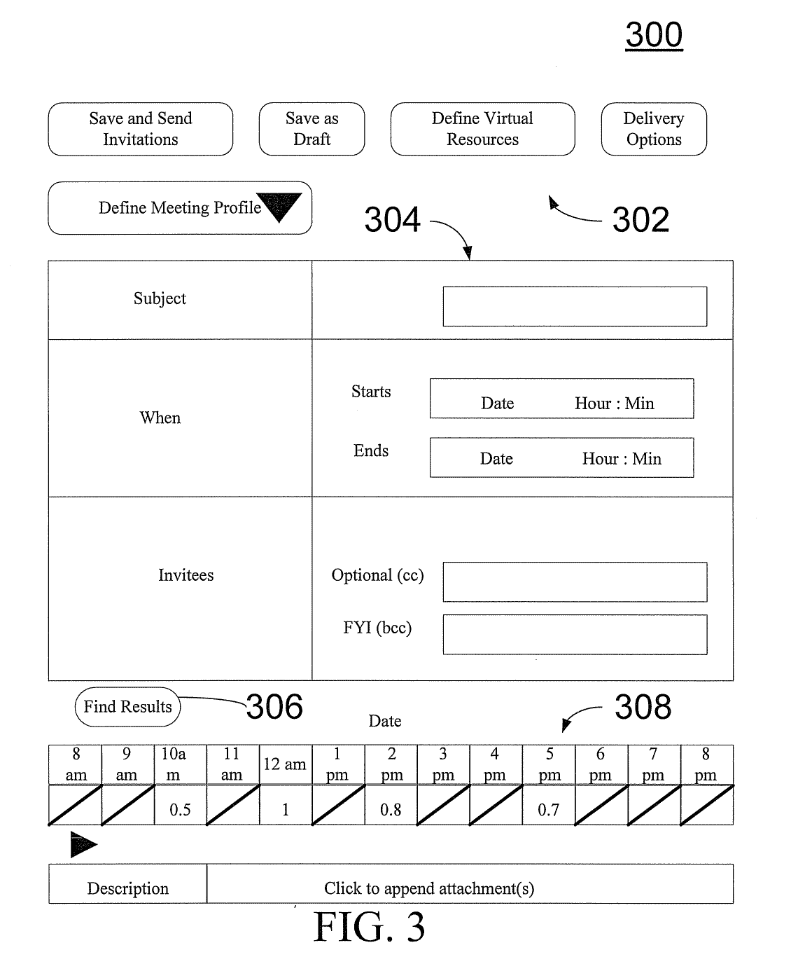

As already noted, the user interface 110 can include a visual display. Referring additionally to FIG. 3, an exemplary graphical user interface 300 is shown, which according to one embodiment can be presented on the visual display of the user interface 110. The graphical user interface 300 enables a user to readily supply input to, as well as interact with, the meeting profiler module 106. The graphical user interface 300 illustratively includes multiple activity buttons 302, with which a meeting scheduler is able to enter input defining a meeting profile. The graphical user interface 300 also illustratively includes boxes 304 in which the meeting scheduler is able to specify using a standard keyboard (not shown) meeting parameters, such as the subject of the meeting, the participants, meeting time, and other attributes not shown explicitly. As described above, based upon this input, the meeting profiler module 106 defines a meeting profile 108 that is used by the profile-resource matching module 112 in matching elements of the set of virtual resources 104 specified in the meeting profile 108 generated by the meeting profiler module 106. By clicking on the exemplary “find results” button 306, the meeting scheduler is able to see on the visual display the results generated by the profile-resource matching module 112. The meeting scheduler also can “click-on” each meeting schedule candidate to see an actual match between the meeting profile 108 and available virtual resources associated with each meeting schedule candidate, as described above.

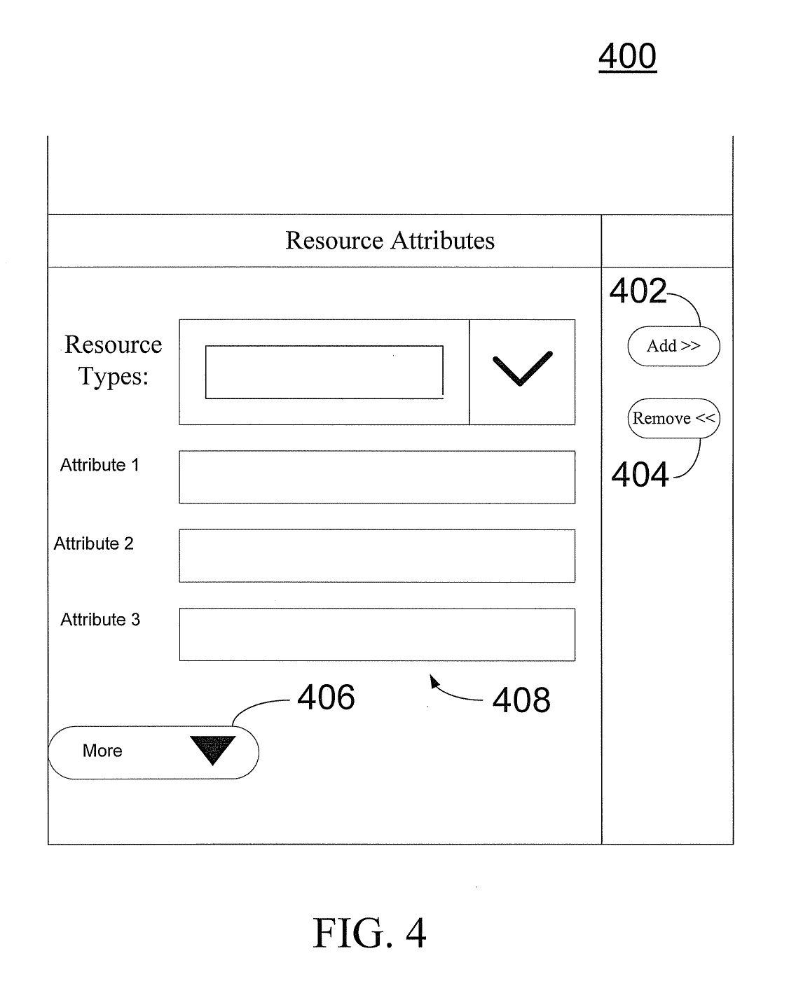

Referring additionally to FIG. 4, an exemplary graphical user interface 400 comprising a Resource Attribute dialog is illustrated. Using different activity buttons 402, 404, 406 of the illustrated graphical user interface 400, a user is able to add and/or remove different types of virtual resources. Moreover, using a standard keyboard, for example, the user can specify properties that are to be associated with a particular virtual resource, the properties being entered into discrete boxes 408 visually displayed. The different virtual resources and their associated properties can then be electronically stored in the electronic data storage 102 as the elements of the set of virtual resources 104.

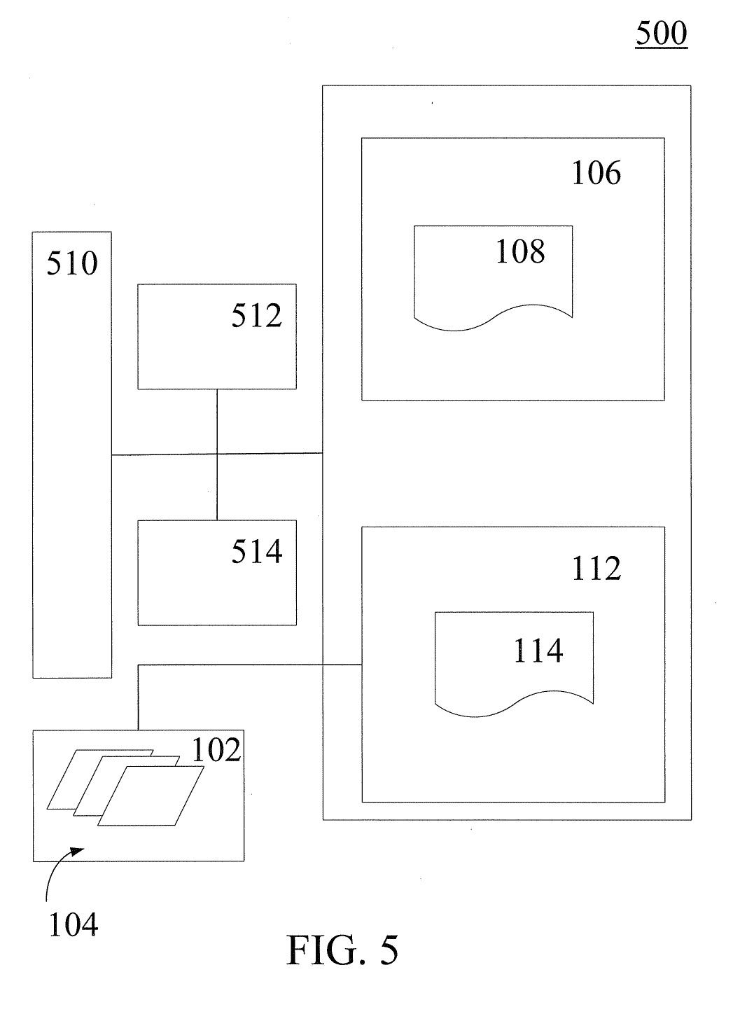

Referring now to FIG. 5, a system 500 for scheduling meetings by matching a scheduler-defined meeting profile against a pool of virtual resources, according to yet another embodiment is schematically illustrated. The system 500 illustratively includes an electronic data storage 102 for storing data defining a set of virtual resources 104 having associated properties, a meeting profiler module 106 for generating a meeting profile 108, and a profile-resource matching module 112 for generating at least one meeting schedule candidate 114. The electronic data storage 102, meeting profiler module 106, and profile-resource matching module 112 are communicatively linked and cooperatively perform the functions described above.

According to this embodiment, the system 500 includes a voice-based user interface 510. The user interface 510 can be a computing device, such as a computer having voice-transmitting-and-receiving capabilities, or a communication device such as a telephone. The system 200 further illustratively includes a speech recognition engine 512 and a text-to-speech 514 engine. With the system 500, a meeting scheduler is able to supply voice input through the user interface 510 that is then recognized by the speech recognition engine 512 and converted into text that can be processed by the meeting profiler module 106 in the manner described above. The results generated by the profile-resource matching module 112 can be converted by the text-to-speech engine 514 into voice output that is relayed to the meeting scheduler through the voice-based user interface 510. In this manner, the system 500 allows a meeting scheduler to obtain one or more meeting schedule candidates 114 based solely on voice-based inputs and outputs. Likewise, these same voice capabilities of the system 500 permit virtual resources 104 and their associated properties to be supplied to the electronic data storage 102 using voice-based input supplied through the voice-based user interface 510.

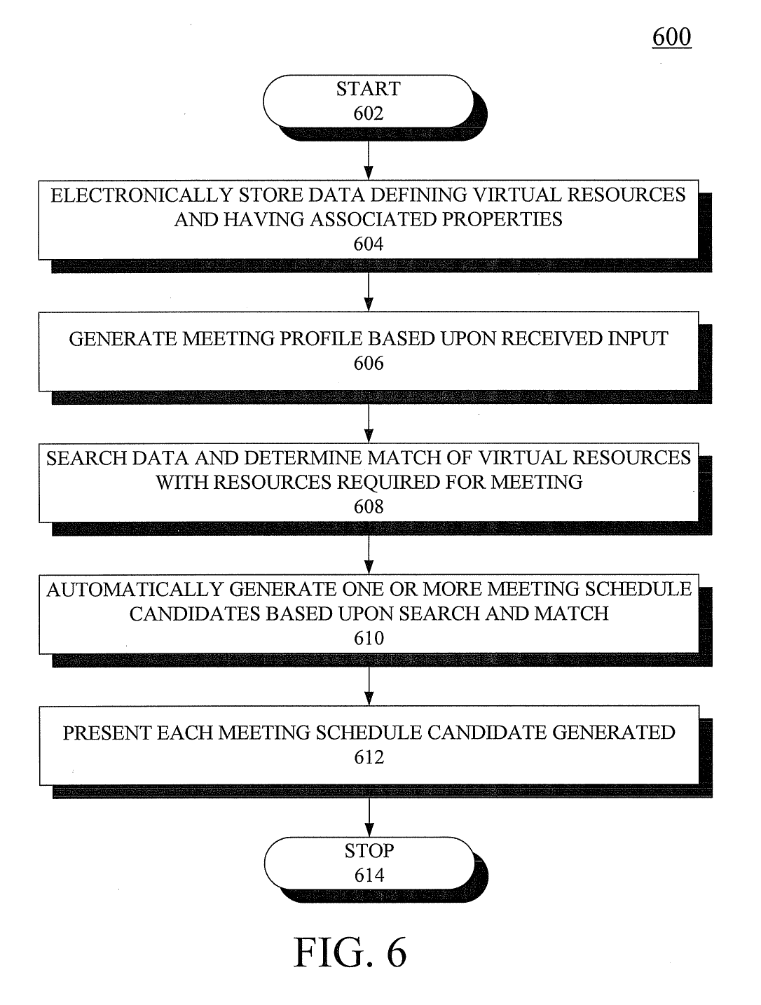

FIG. 6 is a flowchart of exemplary steps in a computer-implemented method 600 for scheduling meetings by matching a scheduler-defined meeting profile against a pool of virtual resources, according to still another embodiment of the invention. The method 600, after starting at step 602, includes electronically storing data defining a set of virtual resources at step 604. Each such resource, more particularly, can have one or more associated properties. At step 606, the method 600 illustratively includes receiving user-supplied input, and based upon the received input, generating a meeting profile. The meeting profile specifies one or more resources required for a meeting.

The method 600 further includes at step 608 electronically searching the stored data to match elements of the set of virtual resources to the one or more resources required for the meeting, as specified by the meeting profile. Additionally, at step 610, the method 600 includes automatically generating one or more meeting schedule candidates based upon the match. The method 600 further includes presenting each meeting schedule candidate so generated to a user at step 612. The method 600 illustratively concludes at step 614.

The method 600, according to one embodiment, can further comprise rank ordering each meeting schedule candidate if more than one meeting schedule candidate is generated. A meeting schedule candidate that can occur with resources whose properties most closely match the specified meeting profile can be assigned a highest rank order, according to another embodiment. More particularly, the rank ordering can be based upon user-specified weights. Each such weight can indicate a relative priority of importance for each resource to be matched against the meeting profile. A meeting schedule candidate having the highest rank, according to one embodiment, can be automatically presented to the user. Each property can be assigned a range of numerical values, according to still another embodiment. Moreover, the assigned range of numerical values can be automatically computed based upon resource specifications indicated in the meeting profile.

According to still another embodiment, the method 600 also can include updating one or more meeting schedule candidates. The updating can occur automatically in response to a change in one or more properties of at least one element of the set of virtual resources. Thus, if any such changes occur prior to a scheduled meeting, meeting schedule candidates can be changed or modified accordingly to reflect the changes.

The invention, as already noted, can be realized in hardware, software, or a combination of hardware and software. The invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The invention, as also already noted, can be implemented with computer-readable code embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The foregoing descriptions of preferred embodiments of the invention have been presented for the purposes of illustration. The description is not intended to limit the invention to the precise forms disclosed. Indeed, modifications and variations will be readily apparent from the foregoing description. Accordingly, it is intended that the scope of the invention not be limited by the detailed description provided herein.

We claim:

1. A computer-implemented method for scheduling meetings by matching a scheduler-defined meeting profile against a pool of virtual resources, the method comprising:
electronically storing data defining a set of virtual resources, each resource having associated therewith at least one property;
generating a meeting profile that specifies one or more resources required for a meeting based upon received user input;
electronically searching the stored data to match elements of the set of virtual resources to the one or more resources required for the meeting;
automatically generating at least one meeting schedule candidate based upon the match; and
presenting the at least one meeting schedule candidate to a user.

2. The method of claim 1, further comprising rank ordering each meeting schedule candidate if more than one meeting schedule candidate is generated, wherein a meeting schedule candidate that can occur with resources whose properties most closely match the specified meeting profile is assigned a highest rank order.

3. The method of claim 2, wherein the rank ordering is based upon user-specified weights, each weigh indicating a relative priority of importance for each resource to be matched against the meeting profile.

4. The method of claim 2, wherein a meeting schedule candidate having the highest rank is automatically presented to the user.

5. The method of claim 1, wherein each property is assigned a range of numerical values.

6. The method of claim 5, further comprising automatically computing the assigned range of numerical values based upon resource specifications indicated in the meeting profile.

7. The method of claim 1, further comprising updating the at least one meeting schedule candidate if one or more properties of at least one element of the set of virtual resources changes prior to a scheduled meeting.

8. A system for scheduling meetings by matching a scheduler-defined meeting profile against a pool of virtual resources, the system comprising:
an electronic data storage comprising data defining a set of virtual resources, each resource having associated therewith at least one property;
a meeting profiler module for defining a meeting profile that specifies one or more resources required for a meeting based upon received user input;
a profile-resource matching module that searches the data of the electronic data storage and matches elements of the set of virtual resources to the one or more resources required for the meeting defined by the meeting profiler module, and based thereon, automatically generates at least one meeting schedule candidate.

9. The system of claim 8, wherein the profile-resource matching module is further configured to rank order each meeting schedule candidate when more than one meeting schedule candidate is generated, wherein the profile-resource matching module assigns a highest rank to a meeting schedule candidate that can occur with resources whose properties most closely match the specified meeting profile.

10. The system of claim 9, wherein the profile-resource matching module is configured to rank order the meeting schedule candidates based upon user-specified weights, each weigh indicating a relative priority of importance for each resource to be matched against the meeting profile.

11. The system of claim 9, wherein the profile-resource matching module is configured to automatically present to a user a meeting schedule candidate having the highest rank.

12. The system of claim 8, wherein each property is assigned a range of numerical values.

13. The system of claim 12, wherein the profile-resource matching module is configured to automatically compute the assigned range of numerical values based upon resource specifications indicated in the meeting profile.

14. The system of claim 13, wherein the profile-resource matching module is configured to automatically update the at least one meeting schedule candidate if one or more properties of at least one element of the set of virtual resources changes prior to a scheduled meeting.

15. A computer-readable storage medium comprising computer-readable instruction for causing a computer to:
electronically store data defining a set of virtual resources, each resource having associated therewith at least one property;
generate a meeting profile that specifies one or more resources required for a meeting based upon received user input;
electronically search the stored data to match elements of the set of virtual resources to the one or more resources required for the meeting;
automatically generate at least one meeting schedule candidate based upon the match; and
present the at least one meeting schedule candidate to a user.

16. The computer-readable storage medium of claim 15, further comprising computer-readable instructions to rank order each meeting schedule candidate if more than one meeting schedule candidate is generated, wherein a meeting schedule candidate that can occur with resources whose properties most closely match the specified meeting profile is assigned a highest rank order.

17. The computer-readable storage medium of claim 16, wherein the rank ordering is based upon user-specified weights, each weigh indicating a relative priority of importance for each resource to be matched against the meeting profile.

18. The computer-readable storage medium of claim 16, wherein a meeting schedule candidate having the highest rank is automatically presented to the user.

19. The computer-readable storage medium of claim 15, further comprising computer-readable instructions to automatically compute an assigned range of numerical values for at least one property based upon resource specifications indicated in the meeting profile.

20. The computer-readable storage medium of claim 15, further comprising computer-readable instruction to update the at least one meeting schedule candidate if one or more properties of at least one element of the set of virtual resources changes prior to a scheduled meeting.
